(19) United States
(12) Patent Application Publication
(10) Pub. No.: US 2016/0027231 A1
(43) Pub. Date: Jan. 28, 2016

(54) DISPLAY-BASED VENDING APPARATUS AND METHOD

(71) Applicant: INTERCONTINENTAL GREAT BRANDS LLC, East Hanover, NJ (US)

(72) Inventors: Frank GUZZONE, Lorton, VA (US); Michael A. MILLER, Elmhurst, IL (US); Paul SCHINDELAR, Balitmore, MD (US)

(21) Appl. No.: 14/775,602

(22) PCT Filed: Mar. 12, 2014
(86) PCT No.: PCT/US2014/024639

§ 371 Date: Sep. 11, 2015

Related U.S. Application Data
(60) Provisional application No. 61/777,644, filed on Mar. 12, 2013.

(51) Int. Cl. G07F 9/00; G07F 9/02; G06Q 20/18

(52) U.S. Cl. CPC G07F 9/006; G06Q 20/18; G07F 9/023

(57) ABSTRACT

A vending-machine has one or more displays that inform the customer regarding available vendable selections and that facilitate the purchase of a selected item. By one approach this display can comprise a touchscreen display. Such an approach can support a highly intuitive interaction between the purchasing context and the customer. A display of dynamic content serves to attract a potential customer, provide the customer with a wealth of information regarding available selections, offer the customer a variety of ways to consider and assess available vendable items, support the building of a customer relationship between the customer and one or more marketing brands, and effect the successful conclusion of a vending transaction.

### RELATED APPLICATION(S)

This application claims the benefit of U.S. Provisional application number 61/777,644 filed Mar. 12, 2013, which is incorporated by reference in its entirety herein.

### TECHNICAL FIELD

This invention relates generally to vending machines.

### BACKGROUND

Vending machines are known in the art. As used herein, references to a “vending machine” (or “vending apparatus” or “vending platform”) will be understood to refer to an apparatus that serves, in the absence of a human custodian, attendant, or operator to provide a customer with some product or service in exchange for some consideration. Millions of vending machines, for example, serve to exchange a customer's proffered coins, currency, or credit for food items or drinks, Many other items are similarly offered via this approach.

By one typical approach, the customer can view the vending machine's product storage area (often through a protective transparent window). This permits the customer to readily understand which products are presently available for vending. In such a case individual item prices are often displayed via a small corresponding sign with each category of item. Such a machine will sometimes respond to depositing of the customer's money by causing the selected item to move in some manner to thereby be released from a holding mechanism and drop down into a receiving area. The customer then reaches into the receiving area to retrieve their selection.

By another typical approach, the customer cannot directly view the vending machine's storage area but is apprised of the available items via displayed samples or signage. Vending machines of this type often devote the bulk of their front exterior to static signage that advises the customer of the machine's contents and also to hopefully tempt the customer to in fact make a corresponding purchase. Such a machine will also often include a small indicator (for example, an illuminated light source such as a small incandescent bulb or a light emitting diode (LED)) to indicate which selections are presently sold out or are otherwise unavailable.

For the most part, promotional possibilities remain quite limited for such vending machines and tend to focus on the provision of static signage and/or a heavy reliance upon display of the machine's inventory storage area. This may be due to a belief that the overall nature of the transaction appears quite simple (i.e., advise the customer of a small selection of items, perceive their selection, and successfully exchange that selection for a monetary consideration) and has not fundamentally changed since virtually the earliest of vending machines.

### BRIEF DESCRIPTION OF THE DRAWINGS

The above needs are at least partially met through provision of the display-based vending apparatus and method described in the following detailed description, particularly when studied in conjunction with the drawings, wherein:

FIG. 1 comprises a flow diagram as configured in accordance with various embodiments of the invention;

FIG. 2 comprises a block diagram as configured n accordance with various embodiments of the invention;

FIG. 3 comprises a front-elevational schematic view as configured in accordance with various embodiments of the invention;

FIG. 4 comprises a flow diagram as configured in accordance with various embodiments of the invention;

FIG. 5 comprises a front-elevational schematic view as configured in accordance with various embodiments of the invention;

FIG. 6 comprises a front-elevational schematic view as configured in accordance with various embodiments of the invention;

FIG. 7 comprises a front-elevational schematic view as configured in accordance with various embodiments of the invention;

FIG. 8 comprises a front-elevational schematic view as configured in accordance with various embodiments of the invention;

FIG. 9 comprises a flow diagram as configured in accordance with various embodiments of the invention;

FIG. 10 comprises a front-elevational schematic view as configured in accordance with various embodiments of the invention;

FIG. 11 comprises a front-elevational schematic view as configured in accordance with various embodiments of the invention;

FIG. 12 comprises a flow diagram as configured in accordance with various embodiments of the invention;

FIG. 13 comprises a front-elevational schematic view as configured in accordance with various embodiments of the invention;

FIG. 14 comprises a flow diagram as configured in accordance with various embodiments of the invention;

FIG. 15 comprises a front-elevational schematic view as configured in accordance with various embodiments of the invention;

FIG. 16 comprises a front-elevational schematic view as configured in accordance with various embodiments of the invention;

FIG. 17 comprises a front-elevational schematic view as configured in accordance with various embodiments of the invention;

FIG. 18 comprises a flow diagram in accordance with various embodiments of the invention;

FIG. 19 comprises a detail front elevational view in accordance with various embodiments of the invention;

FIG. 20 comprises a front elevational schematic view in accordance with various embodiments of the invention;

FIG. 21 comprises a front elevational schematic view in accordance with various embodiments of the invention;

FIG. 22 comprises a front elevational schematic view in accordance with various embodiments of the invention;

FIG. 23 comprises a block diagram in accordance with various embodiments of the invention;

FIG. 24 comprises a flow diagram in accordance with various embodiments of the invention;

FIG. 25 comprises a flow diagram in accordance with various embodiments of the invention;

FIG. 26 comprises a screenshot in accordance with various embodiments of the invention;

FIG. 27 comprises a screenshot in accordance with various embodiments of the invention;

FIG. 28 comprises a screenshot transition in accordance with various embodiments of the invention; and

FIG. 29 comprises a screenshot in accordance with various embodiments of the invention,

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical field as set forth above except where different specific meanings have otherwise been set forth herein.

### DETAILED DESCRIPTION

Generally speaking, pursuant to these various embodiments, a vending-machine has one or more displays that inform the customer regarding available vendable selections and that facilitate the purchase of a selected item. By one approach this display can comprise a touch screen display. Such an approach can support a highly-intuitive interaction regarding the purchasing context for the customer. These teachings readily support the display of dynamic content that can serve to attract a potential customer, provide the customer with a wealth of information regarding available selections, offer the customer a variety of ways to consider and assess available vendable items, support the building of a customer relationship between the customer and one or more marketing brands, and effect the successful conclusion of a vending transaction. Those skilled in the art will appreciate that these teachings are highly flexible and can be leveraged in a wide variety of application settings. It will further be appreciated that these teachings are highly scalable and can be readily employed with a wide variety of vendable items and services.

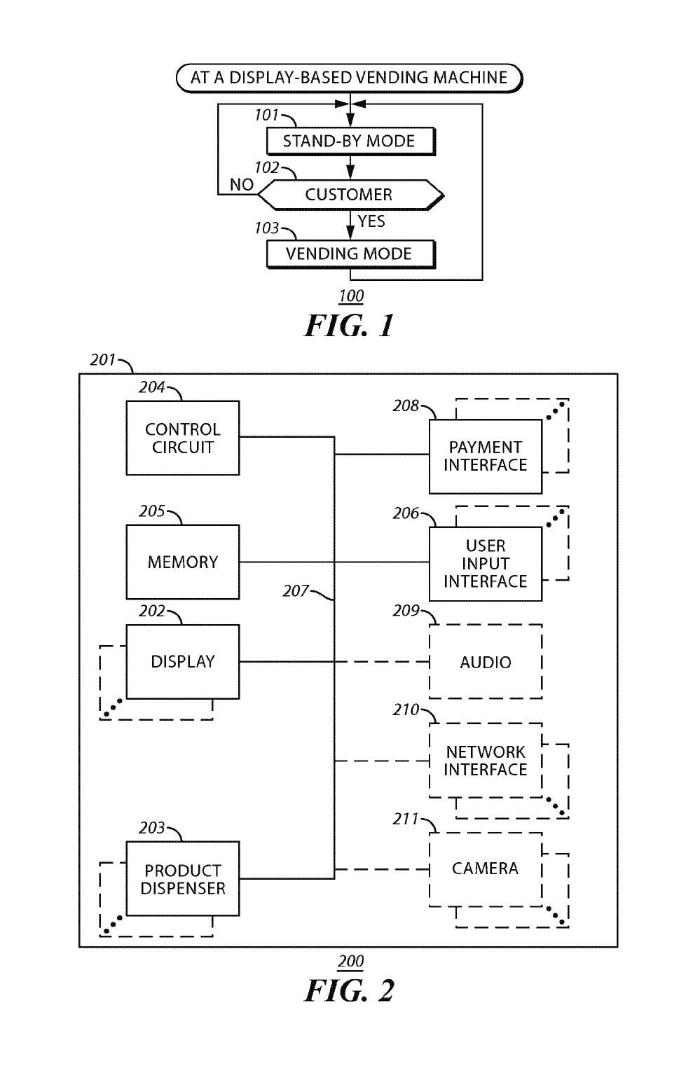

These and other benefits may become clearer upon making a thorough review and study of the following detailed description. Referring now to the drawings, and in particular to FIG. 1, an illustrative process 100 that is compatible with many of these teachings will now be presented. This process 100 can be carried out by a display-based vending machine. Those skilled in the art will recognize that any of a wide variety of architectural and component choices will serve to embody such a machine. For the sake of illustration and not by way of limitation, and referring momentarily to FIG. 2, such a display-based vending machine 200 can comprise a housing 201 having one or more displays 202 (such as, for example, flat-screen video displays as are known in the art) that are viewable by a customer and a product dispenser (or dispensers) 203 to store, retrieve, and physically deliver vendable items/services to a corresponding customer. Such displays 202 and product dispensers 203 are well known in the art. For the sake of brevity and for the purpose of clarity, further elaboration in this regard will not be provided here.

This display-based vending machine 200 can further comprise a control circuit 204 that operably couples to the display 202 and the product dispenser 203 in order to interact with and control such components. Those skilled in the art will recognize and appreciate that such a control circuit 204 can comprise a fixed-purpose hard-wired platform or can comprise a partially or wholly programmable platform. All of these architectural options are well known and understood in the art and require no further description here. This machine 200 can further comprise a memory 205 that operably couples to at least the control circuit 204 and the display 202. This memory 205 can store, for example, instructions to be executed by the control circuit 204 as correspond to the teachings presented herein. This memory 205 can also store, for example, displayable content to be selectively presented via the display 202. (It will be understood that the memory component shown can comprise a plurality of memory elements or can be comprised of a single memory element (as is suggested by the illustration).)

Such an apparatus 200 will also typically comprise one or more user-input interfaces 206 that also operably couple to the control circuit 204. This interface 206 serves to permit a customer to, for example, select a particular vendable item. By one approach, this user-input interface 206 can comprise a related or integral part of the display 202. For example, the display 202 can comprise a touch screen display as is known in the art. So configured, the customer can provide input to the control circuit 204 by touching particular portions of the screen comprising the display 202. One or more of these user-input interfaces 206 may also accommodate other interface paradigms. Examples in these regards include, but are not limited to, cursor control interfaces (such as a mouse, arrow keys, trackball, joystick, or the like), alphanumeric-entry keypads, dedicated (or soft) buttons, switches, or the like, voice-recognition interfaces, gesture-recognition interfaces, gaze-tracking interfaces, and so forth. Such user-input interfaces are generally known in the art and, for the sake of brevity, will not be described further here.

These above-described components can communicate as appropriate amongst themselves via any appropriate network interface. As illustrated, for example, a serial-data bus 207 interconnects these components. This permits, for example, the control circuit 204 to communicate with any of these components as necessary or appropriate and for displayable content from the memory 205 to be readily provided to the display 202. Those skilled in the art will recognize that other possibilities exist in these regards. For example, a star-based configuration could serve to directly link the control circuit 204 to one or more of these components. As yet another example, a daisy chain-based configuration could serve to connect some or all of these components in a loop.

Depending upon the needs of a given application setting, such a machine 200 can readily accommodate other components as well. For example, such a machine 200 will typically have one or more payment interfaces 208. Such payment interfaces 208 are known in the art and can serve to accept payment in the form of coins, currency, credit, debit, and gift card transactions, coupons or tokens, biometrics (as when a customer's fingerprint serves as their virtual credit or debit card), and wireless transactions (as when the customer presents a wireless smartcard, radio frequency identifier (RFID)-based card, module, or the like), to note but a few examples in these regards.

Such a machine 200 can also comprise an audio component 209. This audio component can serve to store and selectively render audible any of a variety of useful sounds. These sounds can accompany and be synchronized with displayed video content or can comprise stand-alone audible content. The audible content itself can comprise any sounds that may be useful or necessary to meet the needs or opportunities as tend to characterize a given application setting. These sounds can include, but are not limited to, human speech, music, sound effects (for example, fanciful sounds or sounds that are appropriate and expected in the context of interacting with a vending machine), or tones or signals of various kinds that serve as alerts, indicators, acknowledgements, or the like.

This machine 200 can also comprise, as desired, one or more network interfaces 210 to thereby provide access to one or more resources external to the machine 200. Numerous examples are known in the art. A non-exhaustive listing would include Universal Serial Bus (USB)-based interfaces, RS232-based interfaces. I.E.E.E. 1394 (aka Firewire)-based interfaces, Ethernet-based interfaces, any of a variety of so-called Wi-Fi™-based wireless interfaces, Bluetooth™-based wireless interfaces, cellular telephony-based wireless interfaces, Near Field Communications (NFC)-based wireless interfaces, standard telephone landline-based interfaces, cable modem-based interfaces, and digital subscriber line (DSL)-based interfaces. Such interfaces can be selectively employed to communicatively couple the machine 200 to another such machine, to a local area network, or to any of a variety of wide area networks or extranets (such as, but not limited to, the Internet).

Such a machine 200 can also comprise, if desired, one or more cameras 211. This can comprise a still camera or a video camera as desired and may have a set field of view or a selectively-variable orientation or zoom capability as desired. Such a camera can be configured, for example, to view (and capture images of) some portion of or all of the customer (or customers) when standing before and/or approaching the machine 200. Such a camera or cameras can be specifically configured, if desired, to provide ordinary light or infrared light imaging and/or depth information.

Those skilled in the art will recognize that the latter components can again operably couple to the control circuit 204 or other components of the display-based vending machine 200 via the depicted serial bus 207 or any other connectivity mechanism of choice.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially-programmable platform as are known in the art.

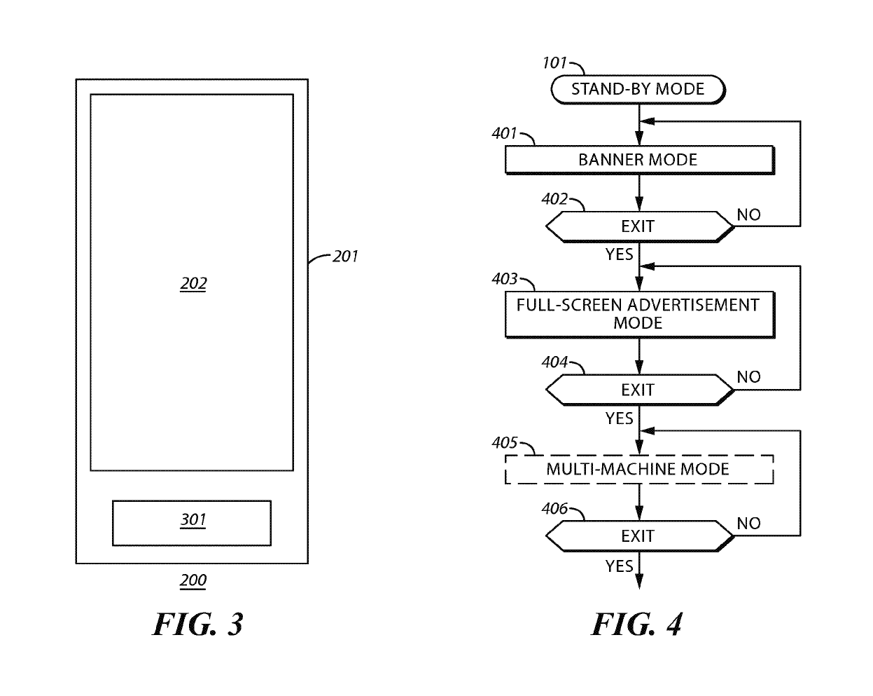

With momentary reference to FIG. 3, this generalized schematic representation of a display-based vending machine 200 illustrates that the display 202 can be mounted on the front side of the machine 200 and can comprise a large portion of that side. As shown, for example, this display 202 can equal greater than thirty percent of the available front surface of the machine 200. As another example, this display 202 can equal greater than forty percent of the available front surface of the machine 200. As yet another example, this display 202 can equal greater than fifty percent of the available front surface of the machine 200. And as yet another example in these regards, this display 202 can equal greater than seventy percent of the available front surface of the machine 200.

In this example, the machine's front side also includes a vended-product delivery area 301. This can comprise an inset compartment into which vended items are placed. The customer (not shown) can then reach into this compartment to grasp and remove their vended item. For the sake of simplicity and illustrative ease, the remainder of this description will presume such a form factor and design for the display-based vending machine 200. Those skilled in the art will recognize that numerous other possibilities exist in these regards, however, and that these teachings are equally as applicable for use with a wide variety of other designs.

Returning again to FIG. 1, it can be seen that this process 100 generally provides for a stand-by mode 101 and a vending mode 103. Generally speaking, the machine 200 operates using the stand-by mode 101 unless and until the process 100 detects at 102 a customer. Such detection can comprise, for example, detecting an input of the customer as delivered via the aforementioned user-input interface 206. Such detection may also comprise, for example, detecting the presence of the customer via processing of captured images from the aforementioned camera 211 by the machine's control circuit 204. Other approaches can serve in these regards as well, including the use of Bluetooth-based detection, proximity detectors of various kinds, and so forth.

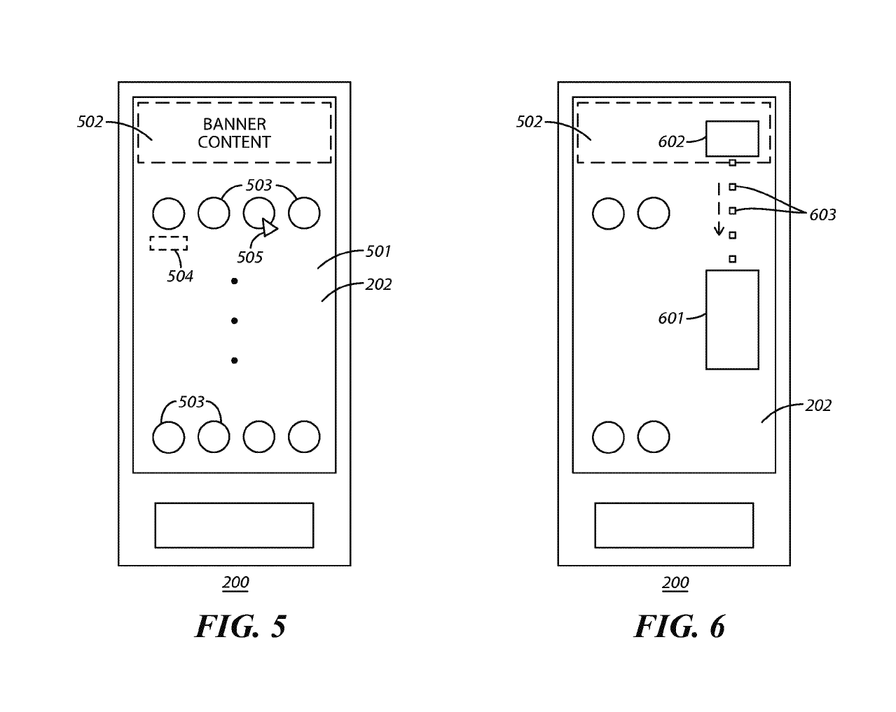

Referring now to FIG. 4, one illustrative approach as regards this stand-by mode 101 will be described. This stand-by mode 101 generally presumes the absence of an immediately-interested customer and therefore generally serves to attract such a candidate. This can comprise using the step 401 of providing a so-called banner mode of operation. With momentary reference to FIG. 5, this can comprise using only a portion of the machine's display 202 to present banner content 502.

In this illustrative example this banner content 502 is situated above a portion of the display 501 that serves to present available vendable items 503 (represented here schematically by circles though it will be understood that these displayed representations can comprise any desired form and shape including a virtual graphic representation of the item itself, such as a bag of peanuts, a small package of cookies, a 12 ounce container of carbonated beverage, or the like). If desired, a corresponding legend 504 can accompany some or all of the individually displayed vendable items 503. This legend 504 can present, for example, price information as pertains to the corresponding vendable item 503 or other information as desired. When the user interface comprises, at least in part, a cursor control mechanism, this display area 501 can also include the corresponding cursor 505. So configured, it will be appreciated that such a display area 501 can appear similar in appearance to many traditional vending machines that feature a live view of the machine's vendable item storage and display area.

In any event, the aforementioned banner content 502 can comprise any of a variety of forms. By one approach this banner content 502 can simply comprise a static presentation of a still image. By another approach this banner content 502 can comprise a slide show of sequentially-offered still images. By yet another approach this banner content 502 can comprise video material offering moving images. Those skilled in the art will appreciate that various combinations of these differing presentation approaches can also be employed in sequence or can even be used simultaneously in different portions of the banner display area.

The substance of this banner content 502 can of course vary with the needs and/or opportunities as tend to characterize a given application setting. As one example, this banner content 502 can serve to use color and motion to attract the attention of passers by. As another example, this banner content 502 can serve to provide the viewer with images directly pertaining to one or more of the vendable items available at this machine 200 (such as animated images of the items as wrapped or presented as a serving suggestion). Other possibilities exist as well in these regards. For example, this banner content can present customer relationship-building material such as, but not limited to, recipes or other related use cases, contact information, charitable sponsorships and opportunities, sponsored events and promotions, social-networking possibilities, other non-machine purchasing opportunities, and so forth. This banner content 502 can also comprise other kinds of information that is not particularly related, in and of itself, to the vendable items or a particular customer relationship. Examples in this regard might include breaking news feeds, weather reports and forecasts, advertisements for products and services of third parties, entertainment content, and so forth.

As described above, this banner content 502 resides within a segregated area of the display 202 to thereby separate that banner content 502 from a display 501 of the vendable item selections. These teachings will accommodate, however, at least an occasional (or constant, if desired) intermingling of the banner content 502 with the primary vendable items display 501. As one illustrative example in these regards, and referring now momentarily to FIG. 6, a particular displayed vendable item 601 can be emphasized (for example, by enlarging the size of the displayed item) while a source of contents 602 for that particular vendable item 601 appears in the banner area and pours its contents 603 out into the displayed container for the vendable item 601.

For example, the emphasized vendable item 601 could comprise a bag of peanuts and the source of contents 602 could comprise a can of peanuts. Using animated elements, the display of the can of peanuts can appear to open and tip over to cause a stream of peanuts to fall down into the waiting bag of peanuts to thereby fill the bag. Such a presentation could of course be accompanied by appropriate corresponding sounds, such as the sound of an opening can and the sound of peanuts falling into a plastic bag. Such a display could sequentially follow, if desired, for a number of the different selectable items to thereby drawn the attention and possible consuming interest of passers by and onlookers.

In the examples shown, the banner content 502 appears at the top of the display 202. This banner content 502, however, can be provided essentially anywhere on the display and can even consume the entire display area if desired. These teachings will also readily accommodate using two or more discrete areas of banner content, including areas having differing sizes, differing shapes, and so forth. It would also be possible for the banner area itself to move in a discontinuous or continuous basis.

Referring still to FIG. 4, this banner mode 401 can persist until the process determines to exit 402 this mode. This exit decision 402 can be based upon whatever decision-making criterion may be relevant to the needs of a given application setting. By one approach, for example, this decision can be time-based. Using this approach, use of the banner mode 401 may continue only for a predetermined amount of time, such as thirty seconds, two minutes, or such other duration as may be suitable. By another approach, and as another example, this decision can be content-based. Using this approach, use of the banner mode 401 may continue until the available banner content has all been used.

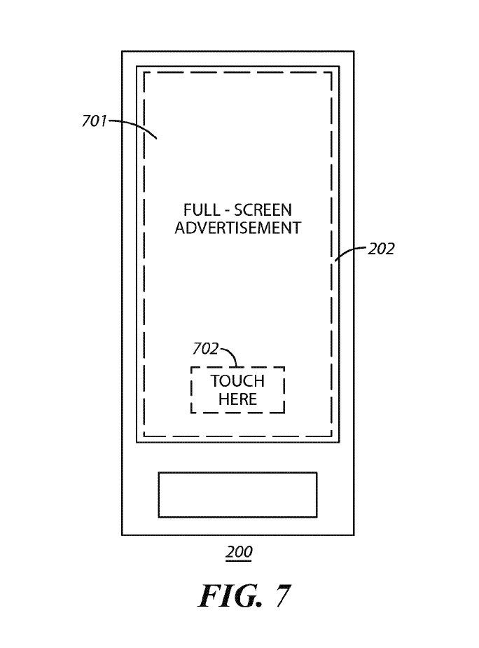

Upon exiting the banner mode 401, and if desired, this stand-by mode 101 can accommodate a full-screen advertisement mode 403. Referring momentarily to FIG. 7, this can essentially comprise using all, or substantially all, of the full display 202. This notion of using the “full-screen” refers to the concept of not displaying, at least momentarily, any of the virtual representations of the vendable items themselves.

The substance of this full-screen advertisement 701 can again comprise promotional and/or non-promotional content as desired. When offering promotional content via this approach, the promotional content can relate directly to the offerings of the vending machine itself 200 or can pertain instead, for example, to related offerings. To illustrate the latter opportunity, this promotional material can serve to make the viewer aware of a discount opportunity for a particular product at a given retail venue. When locating this machine near or inside such a retail venue, for example, such an advertisement can serve to inform a consumer of a potentially highly-relevant purchasing opportunity.

When using this full-screen advertisement mode 403, as noted, the viewer no longer sees the available selectable vendable items. As this may potentially give rise to some uncertainty regarding how to engage the machine 200 in order to effect a vending transaction, a “touch here ” (or the like) soft button 702 can also be provided on the display 202. Upon touching (when using a touch screen), clicking upon, or otherwise selecting this soft button 702, the process can revert to the active vending mode 103 as described herein.

Referring again to FIG. 4, this full-screen advertisement mode 403 can continue until the stand-by mode 101 makes a determination at step 404 to exit. As with the banner-mode exit decision step 402 described earlier, this exit determination step 404 can be based upon whatever exit criteria may be relevant and useful to a given application setting.

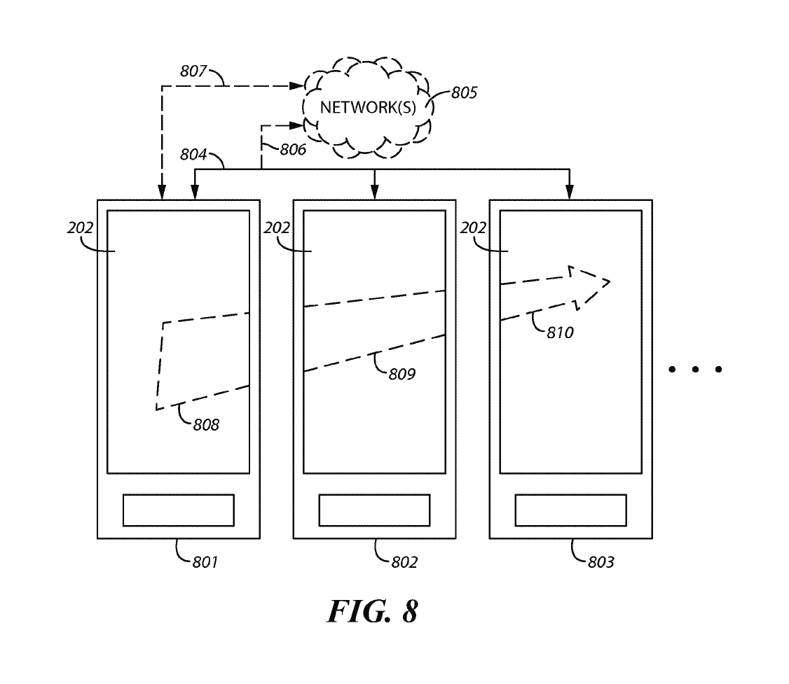

As noted earlier, such a display-based vending machine 200 may interact with other like machines via a corresponding network interface 210. In such a case, and as desired, this stand-by mode 101 will also optionally accommodate a multi-machine mode 405. Referring momentarily to FIG. 8, and by way of illustration and with no intention of suggesting any limitations in these regards, three or more such machines 801, 802, and 803 are coupled one to another via a wireless or a non-wireless serial bus 804. (It is also possible for this bus 804 to couple to one or more other networks 805 (such as the Internet) via a corresponding wireless or non-wireless link 806, or for only a single one of these machines 801 to couple to such a network 805 via its own separate link 807. So configured, these machines 801, 802, and 803 can have access to additional renderable content, pricing information, inventory and replenishment protocols, security resources, and so forth.)

Given such a configuration, the various displays 202 of these machines 801, 802, and 803 can be employed as components of a larger composite display. Using this approach, for example, a first part 808 of a given composite display can appear on a first one of the machines 801, a second part 809 of that composite display can appear on a second one of the machines 802 that is adjacent the first, and a third part 810 of that composite display can appear on a third machine 803 that is adjacent the second. This composite display can comprise a still image or a moving video image as desired. Such a composite display can serve to attract attention and/or to promote, directly or indirectly, an intuitive understanding that these machines are interrelated and may have other interrelated features (with some further examples in such regards being presented below).

Referring again to FIG. 4, a decision step 406 can determine when to exit this multi-machine mode 405 using whatever decision-making criterion may be of interest.

Various exit decisions have been described when offering this explanation of the stand-by mode 101. Generally speaking, these exit decisions are decisions being made in the absence of an interested customer engaging the machine 200. With reference again to FIG. 1, those skilled in the art will understand that the intervention of a customer at step 102 may favorably serve as a real-time or near-real-time interrupt with respect to the execution of the stand-by mode 101.

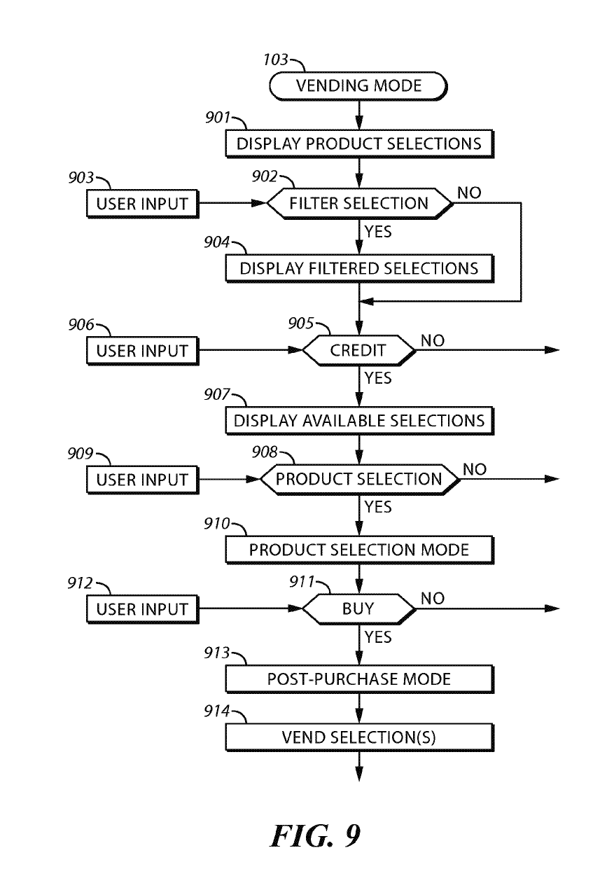

Referring now to FIG. 9, the aforementioned vending mode 103 will be described. As noted earlier, this mode presumes that the display-based vending machine 200 is now interfacing with a potential customer. Accordingly, this vending mode 103 includes the step 901 of displaying available product selections. This can comprise, as described above in conjunction with FIG. 5, presenting a virtual display of all available product selections 503 in a row-based and/or column-based presentation. This can comprise, for example, a pictorial representation of each item as it will otherwise physically appear upon being vended (adjusted, perhaps, for size or shape or by the deletion, addition, or modification of specific textual items, seasonal or promotions-specific content, graphic elements, or the like). Using this approach, for example, a vendable bag of chips will appear on the display 202 as a bag of chips while a vendable box of cookies will appear on the display 202 as a box of cookies.

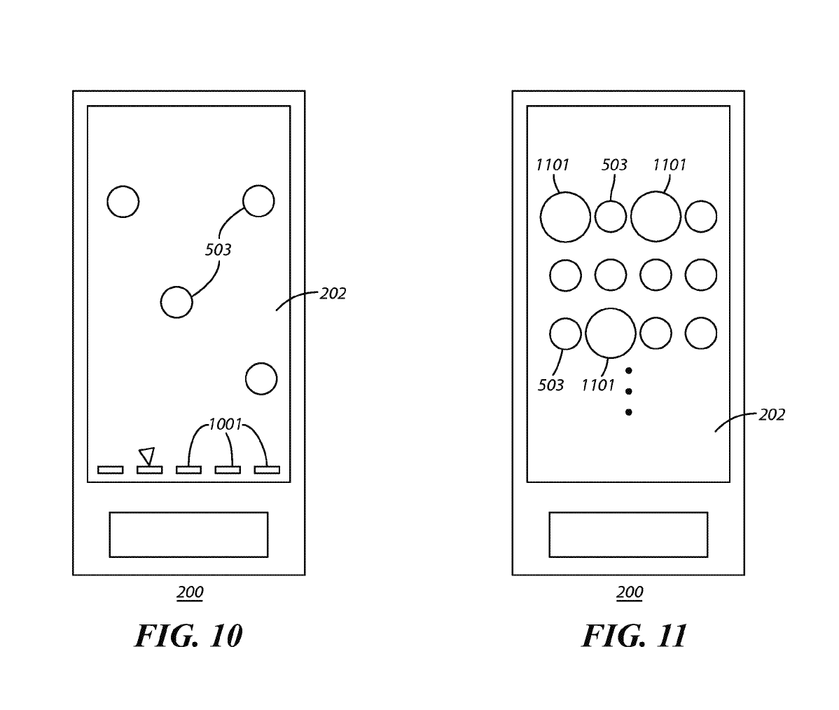

Referring momentarily to both FIGS. 9 and 10, these teachings will accommodate presenting one or more user-selectable filter criteria 1001 on the display 202. These can comprise, for example, criteria by which a customer can choose to winnow down the presentation of selections of present interest. When offering snacks and other food items, for example, illustrative examples in this regard might comprise “low fat,” “salty,” “chocolate,” “non nuts,” “cheesy,” or the like. When offering this option, this vending mode 103 can accommodate the step 902 of detecting corresponding user input 903 in these regards. Upon detecting such an input, this process can then provide the step 904 of displaying the filtered selections.

As shown in FIG. 10, by one approach this can comprise removing items from the display 202 that do not accord with the user's filter selection. This will leave only items 503 that accord with the user's filter selection, thus making it easier for the customer to make their final selection from amongst a smaller population of suitable candidates. Those skilled in the art will appreciate that this response can readily accommodate other approaches as well. As one illustrative example, this step 904 can comprise increasing the size of each item that meets the filter criterion and/or decreasing the size of each item that does not meet the filter criterion. As another illustrative example, the step 904 will accommodate the use of color, contrast, chroma, hue, saturation, brightness, grayscale, or other related adjustments to effect a corresponding visual differentiation between items that meet the filter criterion and those that do not.

It is possible that a customer will insert their money, swipe their credit/debit card, or take another action that results in establishing a credit with the vending machine 200 prior to having indicated any particular item selection. In such a case, and if desired, this vending mode 103 will optionally provide the step 905 of detecting user input 906 that establishes such a credit and prompt the step 907 of displaying selections that are available at that level of credit.

Referring now to both FIGS. 9 and 11, as one illustrative example in these regards, this step 907 can comprise increasing the relative size of items 1101 that are available at the present level of credit with respect to other items 503 that would require a higher level of credit. For example, if the customer had deposited fifty cents into the vending machine 200, then this step 907 could comprise distinguishing the presentation of all items that cost fifty cents or less to permit the customer to easily identify those items that are available at or below that price point. If and as the customer increases the credit level, this process can dynamically respond by adjusting this display of available items in a corresponding manner.

At step 908, this mode detects user input 909 indicating that the customer has selected a particular item. This might comprise, for example, detecting that the customer has touched the display 202 at a location that presents the particular item. When this occurs, this mode can respond with a product selection mode 910.

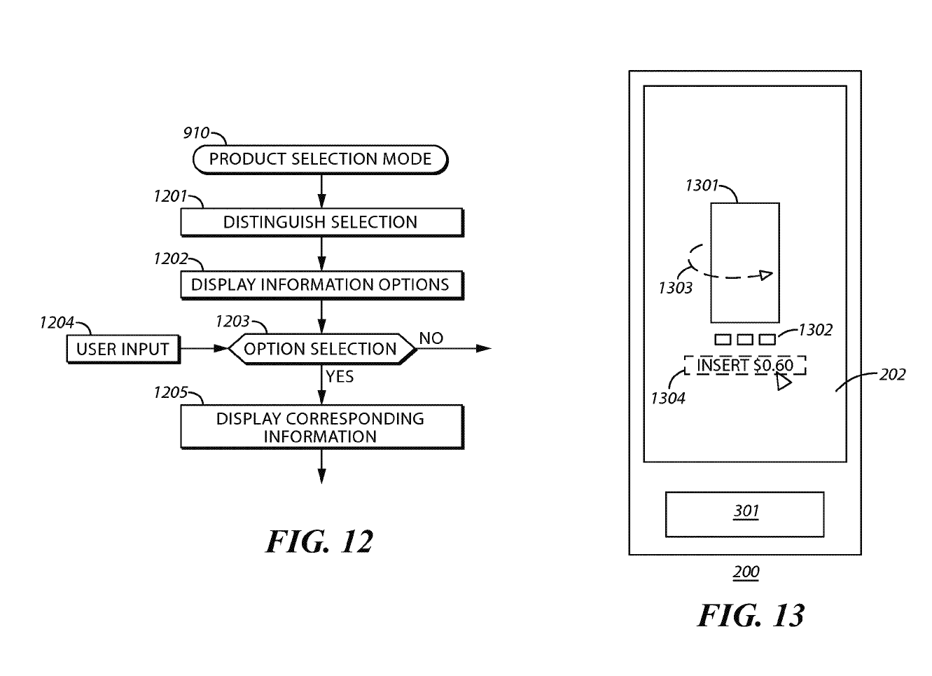

Referring now to both FIGS. 12 and 13, this product selection mode 901 can include the step 1201 of visually distinguishing in some way the selected item 1301 on the display 202. By one approach, and as suggested by the illustration, this can comprise removing some or all of the unselected items from the display 202 (or otherwise reducing their visibility via size reduction, color reduction, contrast reduction, or the like). This can also comprise moving the selected item's virtual representation to a more central location on the display 202 (unless the item is already coincidentally so located) and increasing its size. Such actions make it easier for the customer to perceive and identify their particular selection.

This product selection mode 910 will also optionally support the step 1202 of displaying information options (using, for example, corresponding user-selectable soft buttons 1302 on the display). To illustrate, one such option might comprise a “rotate” option, one might comprise an “ingredients” option, and yet another might comprise a “nutritional information” option. By selecting the “rotate” option button, for example, the customer can cause the displayed virtual item to rotate as indicated by the phantom arrow denoted by reference numeral 1303. By one approach, selecting this button once will cause the item to make a complete 360 degree rotation about its vertical access. By another approach, each selection of this button will cause the item to rotate some predetermined distance such as ninety degrees. By yet another approach, rotation will occur so long as the customer presses the corresponding button.

A rotational option will permit the customer to virtually handle the product and/or its packaging and permit visual inspection of its various sides. The aforementioned “ingredients” option can cause, for example, a corresponding display of textual and/or illustrative information detailing the ingredients that comprise the selected item 1301. Similarly, the “nutritional information” option can cause a corresponding display of textual and/or illustrative information detailing nutritional information for the selected item 1301.

These teachings will readily accommodate numerous variations in these regards. For example, an “open” option could be used to open the virtual packaging for the selected item 1301 and to permit the customer to view the virtual contents of this package. A “dispense” option could be used to present a display of the item being, for example, poured out into a serving dish or the like.

By one approach the product selection mode 910 can provide the customer with an opportunity to specify a quantity of an already-selected item 1301. This opportunity might comprise, for example, a box labeled “quantity” in which the customer can inscribe or otherwise select a given quantity of identical items to be presently vended in this transaction. For example, by one approach the customer might be permitted to specify up to five, or nine, or fifteen identical items in this manner. If desired, the display 202 can present an indication of how many of the selected item are available to purchase at this time. This indication can comprise, for example, a displayed number (such as “3” or “7”) and/or a presentation of a number of the item as are presently available.

By another approach, a user-interface opportunity such as a plus sign can be provided, such that with each assertion of the plus sign the selected quantity increments upwardly by one. Should there be no remaining items available in inventory, the plus sign (or other icon/indicia of choice) can be disabled and this disablement represented by, for example, graying-out the plus sign or using some other graphic convention to indicate this state.

So configured, this product selection mode can provide the step 1203 of detecting such user input 1204 and providing the responsive step 1205 of display ing the corresponding information as described above.

If the customer has not yet established sufficient credit to purchase the selected item 1301, these teachings will accommodate presenting the customer with information 1304 representing the amount required to complete the transaction. This can comprise a dynamic value that changes, for example, as the customer inserts coins to reach the required amount. Once the customer has established a sufficient credit, this display can then present the customer with a “purchase now” (or the like) button.

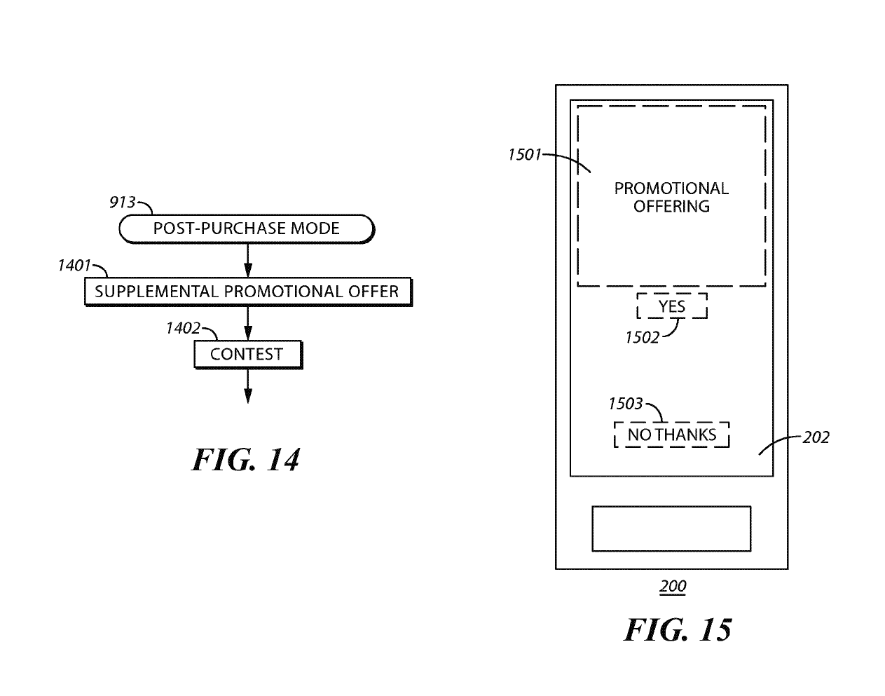

Referring again to FIG. 9, the vending mode 103 includes step 911 to detect user input 912 indicating such a purchase decision. The vending mode 103 responds by effecting a post-purchase mode 913. Referring now to FIG. 14, this post-purchase mode 913 can optionally comprise steps such as the step 1401 of providing a supplemental promotional offer. Referring momentarily to FIG. 15, by way of illustration this can comprise providing a supplemental promotional offering 1501 on the display 202.

For example, when the customer had deposited a one dollar bill and then selected an item costing fifty cents, this promotional offering 1501 could comprise an offer to use the remaining fifty cents in credit to purchase an additional item at discount. This might comprise, say, offering a seventy-five cents item in exchange for the remaining fifty cents.

As another example in these regards, this promotional offering 1501 can comprise an offer to provide the customer with a discount or rebate coupon. This coupon, if accepted, could be printed out by and at the machine 200 or could be emailed to an email address or faxed to a fax number as provided by the customer (using, for example, a displayed touch screen keyboard). As another option, this coupon could comprise a Bluetooth or NFC coupon that the machine 200 provides, upon acceptance, to the customer's cellular telephone, personal digital assistant, loyalty account, or the like.

To facilitate these offerings, the display 202 can present an acceptance button 1502 and a decline button 1503. The customer can then use these intuitive alternatives to indicate their desired result.

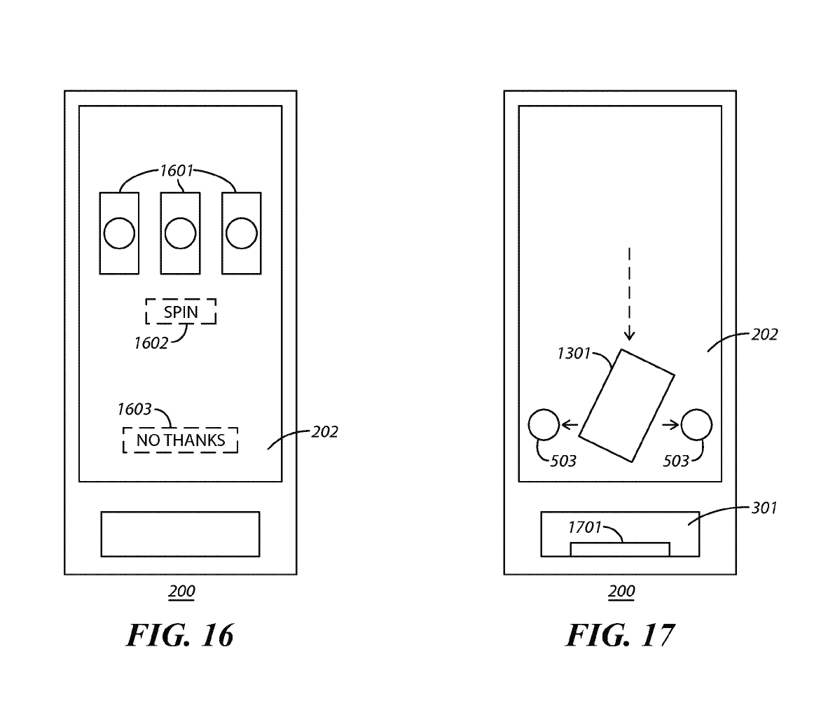

Referring again to FIG. 14, this post-purchase mode 913 can also optionally comprise, alone or in combination with the foregoing, a contest 1402 such as an instant-win game. As an illustrative example in these regards, and referring now to FIG. 16, an instant win game based upon the display of a slot machine can feature a number of windows that each feature spinning shapes. By one approach, these shapes can related to the item that the customer has selected. For example, when the customer has selected a bag of peanuts, these shapes can comprise differently-shaped peanuts.

The customer in this example can select between a “spin” button 1602 and a button 1603 to decline participating in the instant-win promotion. Declining will prompt the process to exit this activity. The “spin” button 1602, however, will cause the shapes in the windows 1601 to appear to spin. Like a slot machine, the revolving shapes in the windows 1601 will slow down and eventually stop. The combination of the particular shapes appearing in the window when this occurs then indicates whether the customer has won or lost.

By one approach, the winning customer can be immediately rewarded. This can comprise, for example, permitting the customer to select one or more additional items from the machine 200 without cost. By another approach, and as may be appropriate when rewarding the customer with a prize that cannot be suitably administered via the machine, the winning customer can be provided with a telephone number (such as a toll free telephone number) to call or text along with a winning code value to present to validate their winning status.

Referring now to both FIGS. 9 and 17, the vending mode 103 in this illustrative example concludes with the step 914 of vending the customer's selection or selections. By one approach, this vending activity can simply comprise physically moving the selected item 1701 to the area 1301 where the customer can receive the item 1701 and remove it from the machine 200. This activity can also comprise returning change, if any, to the customer, providing a printed (or wirelessly transmitted) receipt to the customer, providing a “thank you” message to the customer, and so forth.

As illustrated in FIG. 17, this vending activity can also comprise further use of the display 202 if desired. By one approach, for example, the physical vending of the selected item 1701 can be accompanied by the virtual dropping of the depiction 1301 of the selected item from its previous position down towards the receiving area 301. Other related animations, if desired, can be employed as well. As one simple example in this regard, other non-selected items 503 as may be present on the display 202 can appear to move aside to make room for the dropping selected item 1301.

Those skilled in the art will appreciate the great flexibility, scalability, and leveragability offered through implementation of these teachings. Consider, for example, the synergies that are available by networking two or more such machines 200. A customer at one such machine can be presented with an opportunity to select a combination purchase (such as a so-called value meal) from amongst this plurality of machines. The display 202 for this first machine can present this customer with the aggregated purchasing opportunities for all of these machines. The customer, in turn, can make selections from this aggregation, and can pay for these selections while at this one machine. The customer can then visit the other machines to retrieve their purchases.

As another related example, discounts can be offered to a customer who makes a multi-machine purchase as described above. Also as another related example, the displays of these various machines can be utilized in favor of this one customer to, for example, guide the customer to the appropriate machine(s) following the purchase event to retrieve their items.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

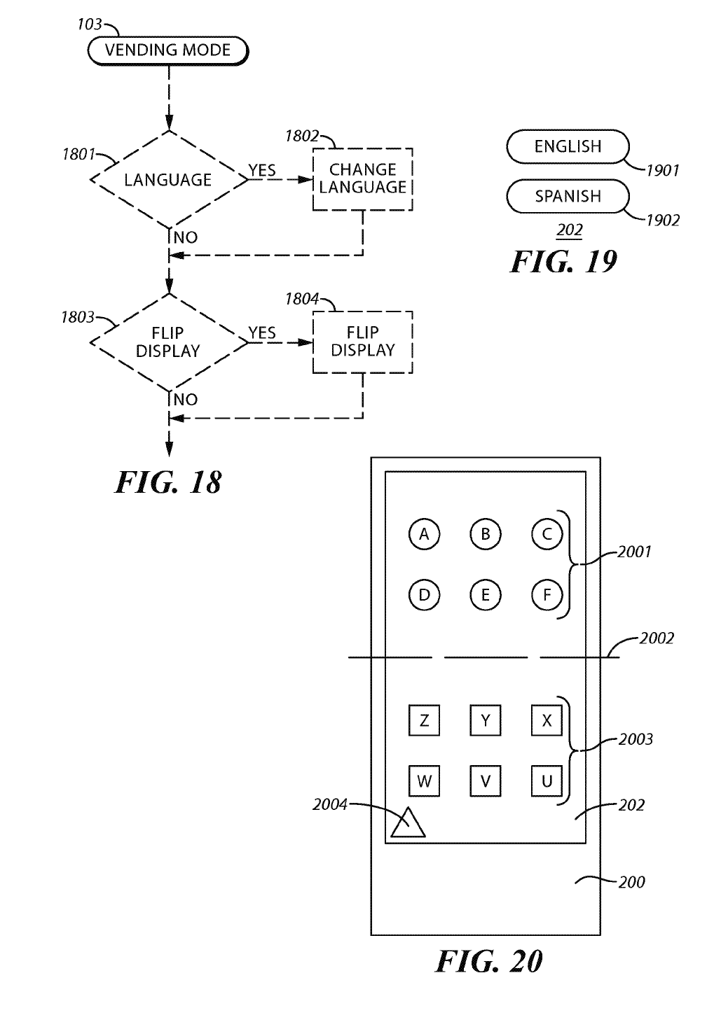

As one example in these regards, and referring to FIGS. 18 and 19, during the aforementioned vending mode 103 a choice of available languages can be presented on the display 202 (such as, for example, the English language 1901 and the Spanish language 1902). Upon detecting at 1801 a particular customer selection in these regards, at 1802 at least some of the language employed to communicate with the customer can be changed to reflect the customer's language selection. This can comprise, for example, presenting product nutritional information, transaction-specific instructions, and so forth in the selected language. This information regarding a choice of language can also serve to call up specific corresponding banner content and/or other promotional content, pricing, purchasing options, and so forth if desired.

As another example in these regards, and referring now to FIGS. 18 and 20, it may be noted that a first grouping 2001 of vendable items are displayed in an upper portion of the display 202 while a second remaining grouping 2003 of vendable items are display ed in a lower portion of the display 202. For the sake of an illustrative example, as shown here the first grouping 2001 appears above a half-way point 2002 and the second grouping 2003 appears below that half-way point 2002.

With the foregoing in mind, the display 202 can further include a virtual button 2004 or other interface opportunity by which a customer can flip or invert a present presentation of the vendable items, i.e., the customer can change the display so that images in an upper region of the display move to a lower region, and vice-versa. Upon detecting the customer's selection of this opportunity 2004 at 1803, the presentation of the vendable items are inverted 1804. If desired, the display 202 can revert back to the original presentation of vendable items following some time-out period of choice or some other trigger event of choice.

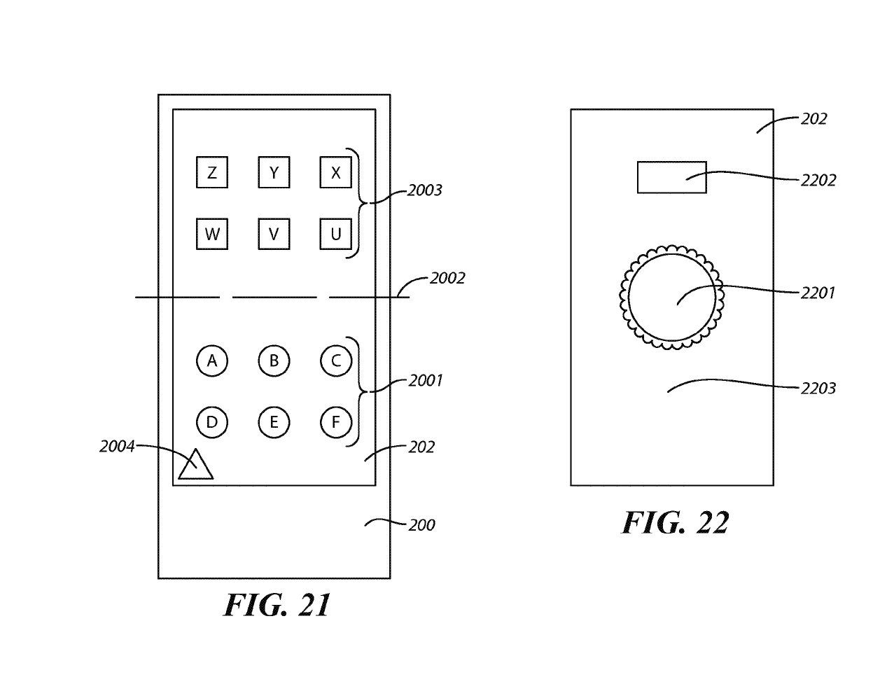

There are various ways to accomplish such an inversion. In FIG. 21, the inversion comprises a simple switching of the first group 2001 of vendable items for the second group 2003 of vendable items. Such a capability can make it easier for persons of diminutive stature, persons in wheelchairs, and persons who might otherwise find it difficult to reach the higher portions of the display 202 to nevertheless have ready and convenient access to their selections.

As yet another example in these regards, the control circuit 201 can be configured to seamlessly integrate the various content items provided via, for example, the display 202. When switching from one kind of content display to another, for example, the control circuit can operate to prevent or minimize visually-perceptible artifacts that might otherwise arise in these regards. By one approach, this can comprise making dynamic use of display screenshots. For example, the control circuit can capture a screenshot of the display 202 when display ing a full screen advertisement and then using that screenshot to seamlessly fade into (or between) a product grid selection screen. Creation, maintenance, and deletion of that screen shot image can be as dynamic as may be desired and/or appropriate to current operating circumstances.

As yet another example of seamlessly combining promotional content (as provided, for example, by a first remote source on the one hand and vend-specific content on the other hand), the control circuit can simultaneously present both the promotional content and the vend-specific content (as is generally described above) by overlaying the former with the latter. In such a case, the vend-specific content presentation can include one or more windows formed therein through which the underlying promotional content can be viewed.

FIG. 22 depicts yet another example in these regards. In this example, the display 202 provides a full-screen post-vend user-interaction opportunity. As part of that opportunity, the display includes a specifically marked area 2201 where the user is invited/instructed to touch the display 202 in furtherance of some specific purpose (for example, to draw a smiling face in that marked area 2201). In such a case, the control circuit 204 is configured to interpret user touches within that marked area 2201 as constituting an interaction with that specific engagement paradigm. If and when the user should touch the display 202 outside of that marked area 2201, however, either within a specifically marked area 2202 or within an unmarked area 2203, the control circuit 204 will interpret those user touches as constituting an instruction to exit this engagement paradigm and to return to a vend-ready user interface. By detecting whether a user's touch-based interaction with the video display 202 corresponds to displayed promotional content or not, the control circuit 204 again contributes to a seamless combination of the various kinds of content and user interactions that are available.

As alluded to above, such a vending machine can communicate with one or more remote sources as desired. This remote source (or sources) can facilitate providing information from the vending machine (regarding, for example, available inventory and/or present sales information, operating status, and so forth) to a corresponding administrator as well as providing information to the vending machine (regarding, for example, pricing changes, updated planograms, new promotional content, and so forth).

As but one illustrative example in these regards, and by one approach, the aforementioned vending apparatus control circuit 204 can comprise a processor 2301 that executes any number of corresponding applications as per the foregoing teachings. In addition to operably coupling to the aforementioned vending apparatus network interface 210, this processor 2301 also operably couples to one or more vending components 2302 and/or one or more peripheral components 2303. (It will be understood that these components of the control circuit 204 may themselves comprise a wholly or partially-programmable platforms. These teachings will also accommodate permitting this processor or any of these components to themselves comprise a plurality of physically-discrete albeit networked or otherwise operably coupled elements.)

These various elements can be operably coupled to one another, for example, via serial and/or USB cables if desired. Other approaches of course exist in these regards.

By one approach the processor 2301 comprises a custom built personal computer with one such computer per vending machine. Such a personal computer can support a number of logical components including, by way of example, a PC image, a monitor application, a service host application, and a vending interface application.

The aforementioned PC image can be preloaded prior to deployment in the field. This PC image can include the prerequisites for running documented applications, drivers for known peripherals, required operating system components, remote access software, and so forth as desired. This approach ensures a known platform for development, testing, and support while also reducing deployment time and increasing deployment success. Such a personal computer can be configured, if desired, to power upon receiving power via BIOS settings.

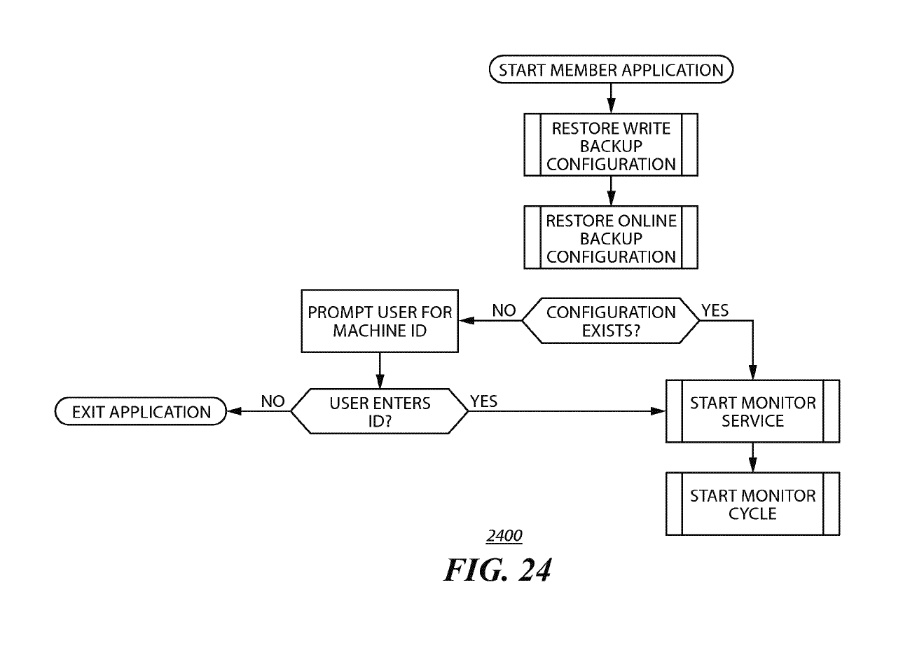

By one approach the aforementioned monitor application has three primary areas of functionality; configuration, applications, and real-time status. When initiated, this monitor application automatically checks for existing configuration information on the local machine. When unavailable, the monitor application prompts the user to enter a machine identifier (ID). The monitor application then uses that machine ID to retrieve full configuration information from a remote source. The monitor application will continue checking for updated configuration information at regular intervals as desired, and update the local information as appropriate. FIG. 24 depicts a flow chart 2400 that illustrates various aspects in these regards.

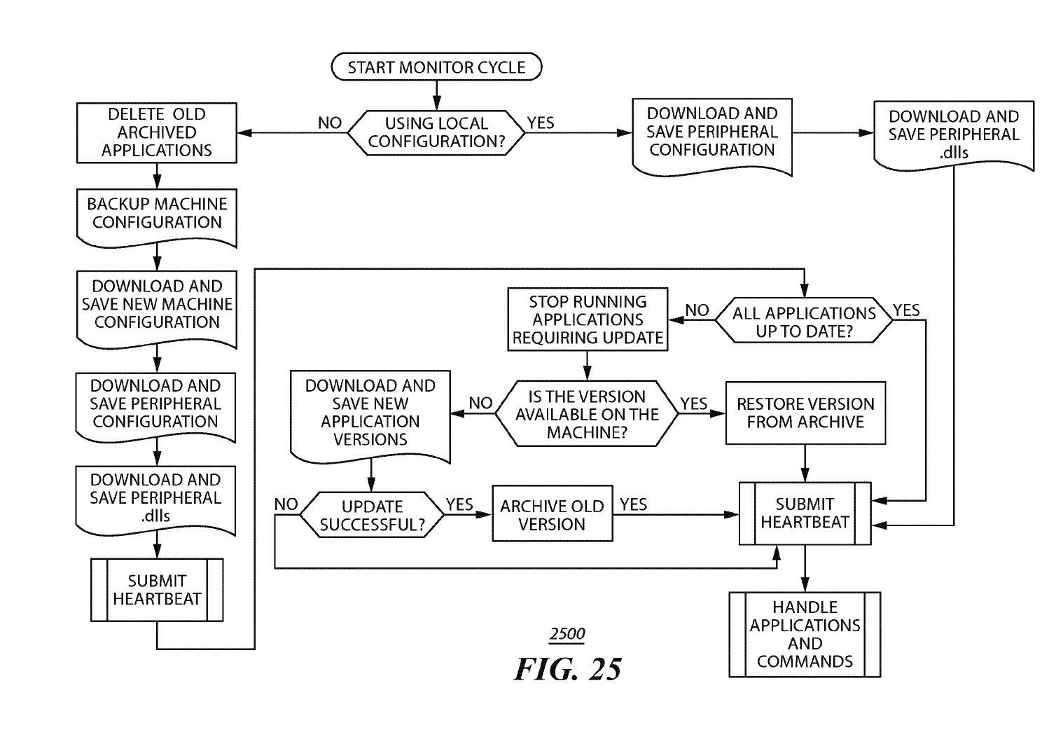

This configuration information determines what applications the PC should run. When those applications are locally unavailable the monitor application can automatically initiate a corresponding download. Once all applications are locally available the monitor application can start them in a configured order. When and as any application exits unexpectedly the monitor application can automatically restart that application. FIG. 25 comprises a flow chart 2500 that illustrates the monitor applications activities in these regards. In particular, the monitor application can run in a repeated cycle (with the interval being defined, for example, in an application configuration file). During this cycle the monitor application manages machine configuration updates, application updates, running applications, and commands from a remote server (described below).

By one approach the monitor application executes a process to update the vending machine and peripheral configurations that includes first creating a backup of the current configuration file. Using this approach, should the monitor application unexpectedly shut down during the update process, a backup position is available. The monitor application then downloads a new machine .XML file via a web service call and saves it to be used as the current machine configuration.

That machine .XML file should contain information about the online status, machine ID, location ID, and configured applications. An example of such a file appears as follows:

<?xml version=“1.0”?>
<Machine xmlns:xsi=“http://www.w3.org/2001/XMLSchema-instance”
xmlns:xsd=
“http://www.w3.org/2001/XMLSchema”>

<UsingLocalConfiguration>false</UsingLocalConfiguration>
<MachineId>59</MachineId>
<LocationId>36</LocationId>
<Applications>

<Application ApplicationId=“6” Name=“Service Host
Application” Description=“Service Host
Application” ApplicationVersionId=“188” Version=“4.2.4.1”
Exe=“Clarity.Diji.ServiceHost.exe”
ExeArgs=“$machineId” Priority=“1” StartupTimeMillis=“7500”
/>
<Application ApplicationId=“22” Name=“TemplatedSampling”
Description=“Templated Sampling
Application” ApplicationVersionId=“174” Version=“1.0.2.4”
Exe=“Kraft.TemplatedSampling.exe”
ExeArgs=“$machineId” Priority=“2” StartupTimeMillis=“0” />

</Applications>

</Machine>

At regular intervals the monitor application can also automatically send data to a remote backend (with a particular illustrative example of a remote backend being provided further herein). This data, by one approach, can define the current status of the vending machine. This information can include, for example, PC-specific information (such as CPU and memory usage metrics) as well as application and peripheral status. By one approach, the monitor application sends this data as a heartbeat message. This heartbeat message can include at least one of and, by one approach, all of vending apparatus identification information and vending apparatus status information (including, for example, PC name, IP address, MAC address, total and available memory, total and available disk space, and CPU utilization percentage), peripheral component status information (including, for example, information for each configured peripheral such as application name and status (i.e., running, not running, shutdown, and so forth), type, specific peripheral instance name, status (such as idle, busy, disconnected, and so forth), and a message explaining the status), and application status information.

The aforementioned service host application can serve as middleware that provides simple interfaces to other applications regarding use of hardware and data services. This can include vending functionality (to facilitate integrating all vending activities behind a single command structure), inventory functionality (for example, by maintaining local files that track available products and their current availability levels), peripheral functionality (to facilitate integrating all peripherals behind a single interface for each peripheral type), digital assets functionality (pertaining, for example, to the identification of all product images and other digital assets and the downloading of same as appropriate), and data aggregation functionality (to permit, for example, submitting error, vendor, and user activity data to a remote server).

As regards peripherals, the service host application can open a communication channel to allow other applications to command peripherals. By one approach the service host application can also support permitting external applications to subscribe to certain notifications. By this approach an application can enable a peripheral and be notified of any corresponding interaction. For example, an application can enable a barcode scanner and receive scan data when a bar code is scanned.

The service host application can facilitate interaction and management of a variety of peripherals. Examples include but are not limited to scanners, smart card readers, motion cameras, LED controllers, payment controllers, and so forth. By one approach, these teachings will accommodate permitting peripherals for a given vending machine to be selected via a web administration portal machine at its configuration page. This approach can include, if desired, using a drop-down list from which a user can select one or more peripherals as correspond to the machine in question.

By one approach, upon initial execution the service host application creates and hosts the peripheral service, a local web service that exposes peripheral commands to external applications via an API. Supported services can include permitting clients to get peripheral types (by, for example, allowing clients to request a listing of known peripheral types), get command types (by, for example, allowing clients to request a listing of known peripheral commands), allowing clients to subscribe to notifications from specific peripheral types (for example, bypassing a handler URL for the notifications), and allowing clients to unsubscribe to thereby remove existing subscriptions.

As regards digital assets, by one approach the service host application retrieves digital asset metadata from a remote resource and saves that information locally. Such metadata can define the digital assets that serve to populate, for example, a current (or available) program and/or displayogram. (A planogram specifies the internal arrangement of products in the vending machine whereas a displayogram specifies the arrangement of products as presented on the display 202.)

As regards data aggregation, the service host application can facilitate sending user activity data, vending results, and error logs to one or more remote servers as desired. An API of choice can permit data from one or more other applications to be submitted in this fashion. So configured, such applications need only understand the service host API and do not require knowledge regarding the backend or how specifically to submit data to that backend.

The aforementioned vending services application can comprise an interactive application that leverages the functionality provided by the service host application. Generally speaking, the vending service application serves to present end-users with available products and to facilitate local purchase of those products, and also to present end-users with promotional content including a variety of advertisements and directed marketing materials.

At startup, the vending services application pulls in the available digital assets and uses those materials to display a product grid on the display 202 in accordance with the current displayogram. The vending services application uses APIs provided by the service host application to thereby know which products are available, the cost of such products, and how much credit the end-user presently has available. The flow of the vending services application can vary dynamically in response to, for example, user touches with respect to displayed three-dimensional models, nutritional information and ingredients, shopping carts, and so forth. The display of promotion content can be as per the descriptions provided above.

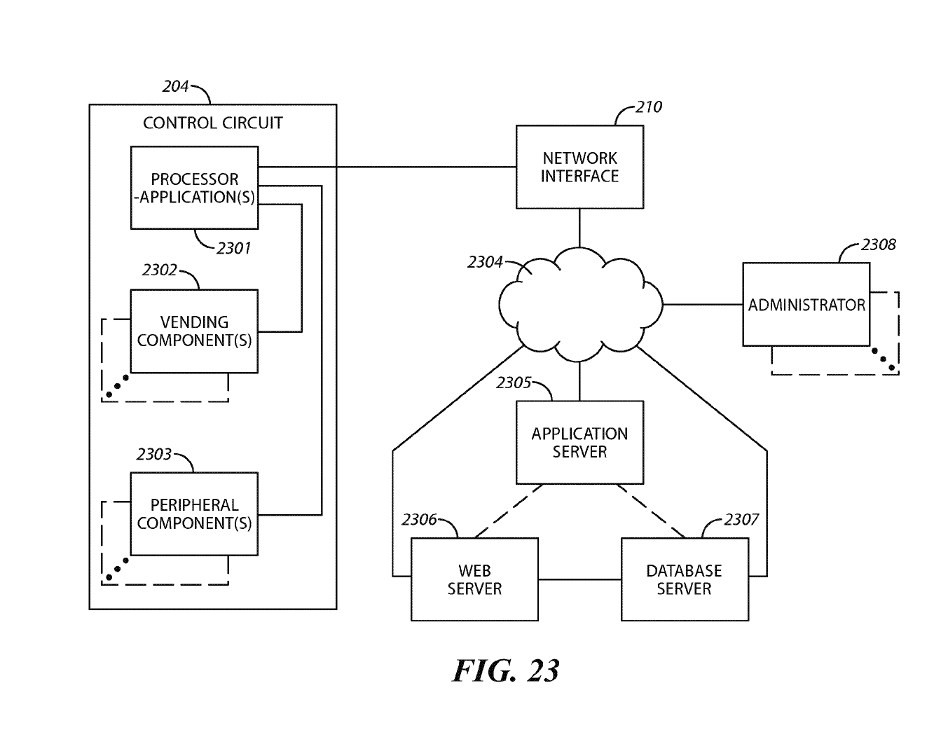

Referring again to FIG. 23, and as suggested earlier, the control circuit 204 can operably couple via the network interface 210 (and via one or more networks to 304 such as, but not limited to, the Internet) to a remote backend that includes, in this illustrative example, an application server 2305, a Web server 2306, and a database server 2307.

The database server 2307 can serve to store a variety of files and information including, but not limited to, promotional content in various formats, digital assets as referred to above, and so forth. The Web server 2306 can comprise a web administration portal (that constitutes a management website offering real-time dashboard information as well as configuration and reporting capabilities for vending machines in the field) and the SWEET service (the latter comprising a known web service that interacts with the SWEET CMS system to allow services from the application server 2305 to access the SWEET media library).

The aforementioned application server can include a wide variety of logical components. These logical components can include, but are not limited to:

a data aggregation service component comprising a Window service that interprets data submitted by the service host application and places corresponding content in an appropriate database location in addition to deciding, at least in some instances, how the data should be additionally handled (for example, the data can serve to trigger one or more alert services comprising the automatic sending of an email to previously-identified email addresses per a corresponding alert subscription opportunity, such that alerts can be sent when, for example, vendable-item inventory for a particular spiral is less than a predetermined configurable percentage, in the event of a dispensing failure, in the event of a hardware failure or communication timeout, in the event of insufficient funds or an out-of-stock event, when a monitored temperature drops too low or rises too high, in the event of a power outage, upon detecting a vandalism attempt, in the event of computer events such as low memory or high CPU utilization, and so forth);

a digital asset service component comprising another Windows service that functions to ensure that all assets in SWEET are up to date and available for downloading;

a digital asset web service component that allows the service host application to query for appropriate product asset listings and download them to the vending PC memory;

a health service component that can serve, for example, to receive, interpret, and react to the aforementioned heartbeat messages (for example, by automatically sending an email alert to one or more predetermined email addresses when a given vending machine fails to provide a heartbeat message for more than some predetermined period of time such as 20 minutes and/or by automatically sending an email alert upon again receiving a heartbeat message when no heartbeat message has been received for some predetermined period of time);

a VDI service component which provides Web service-based access to vending data conforming to the standard vending data interchange (VDI) definition);

a vending inventory service component; and

an application upload Windows service component comprising, for example, a Windows service that packages newly-uploaded applications for download.

Referring again to FIG. 23, these teachings will also accommodate one or more administrator stations 2308. These administrator stations 2308 can comprise, for example, properly programmed personal computers or the like. Such an administrator station 2308 can also communicatively couple to the remote backend via one or more intervening networks 2304 in accordance with well understood prior art technique. More particularly, these teachings will accommodate permitting such administrator stations 2308 to interact with one or more vending machines as described above via the remote backend.

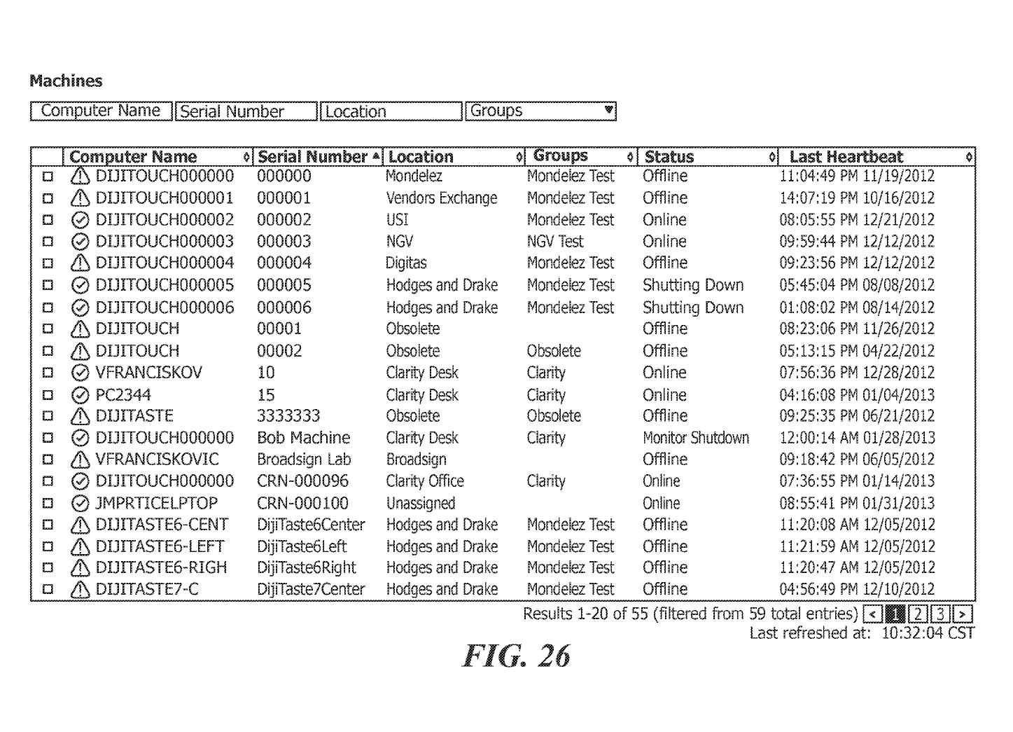

For example, these teachings will support providing a dashboard via the administrator station 2308 that presents information about all of the machines for a given operator. FIG. 26 provides an illustrative example of such a dashboard. The displayed information in this example include the machine's computer name, serial number, physical location, group, status, and last heartbeat information. If desired, rows representing the machines can be sorted using any of the displayed information columns. These teachings will also accommodate filtering displayed results as a function of computer name, serial number, location, and/or group(s). Paging buttons (in this illustrative example located below the lower right corner of the display grid) can facilitate navigating between grid pages.

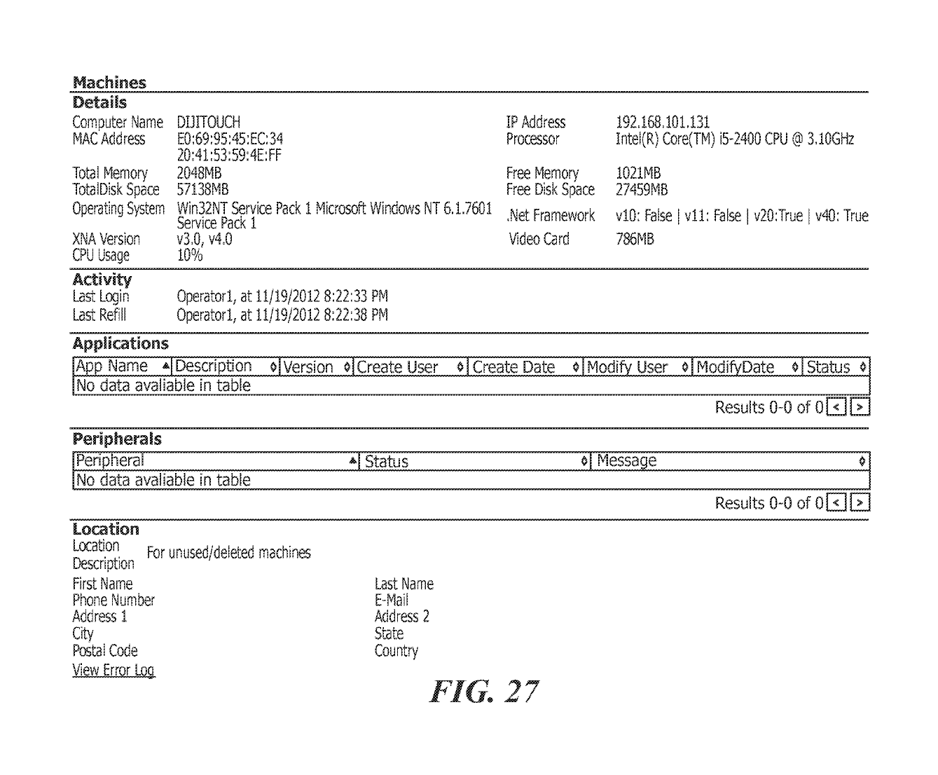

Clicking the icon to the left of a given machine's computer name will, in this example, bring up a details page for that particular machine. FIG. 27 provides an illustrative example of a detail page for a specific machine. The information provided in the details page is of grater depth than that presented on the primary dashboard display described above. For example, the activity area shows dates of the last successful service host application login and the latest refill of the machine. This details page also provides details about applications assigned to the machine including application name, description, version, create, create date, modify user, and modify date. As another example in these regards, a location section provides information about the machines location (such as the physical address) and a contact assigned to that location.

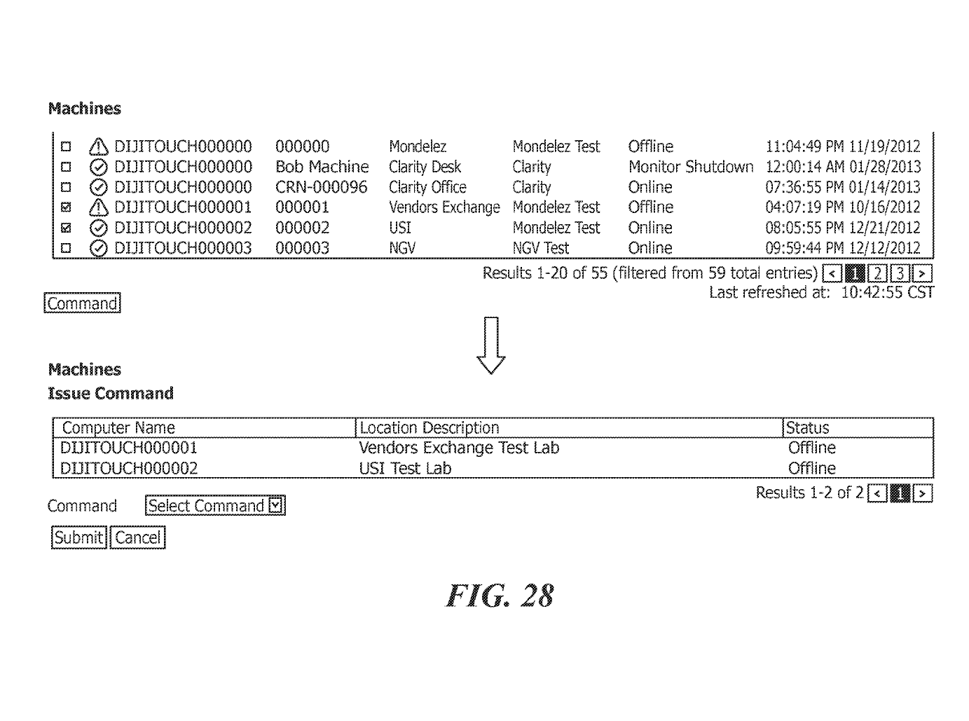

These teachings will also facilitate permitting an operator to issue commands to one or more vending machines via such an administrator station 2308. In particular, the aforementioned web administration portal can serve to issue commands directly to specific machines. By one approach, the user begins such a process by clicking the check boxes in the leftmost column of the aforementioned dashboard display as shown in FIG. 26 to identify the machines that are to receive a command. Referring now to FIG. 28, a “command” button will appear at the bottom of the page if at least one checkbox has been clicked.

This issue command page, in this example, permits the user to select from amongst a plurality of available commands. Depending upon a particular command selected, an additional parameters field may also appear. By one approach, the available commands that can be remotely sourced by a user and acted upon by a targeted vending machine include:

a shutdown machine command to cause the vending machine computer to shut down;

a restart machine command to restart the vending machine computer;

a shutdown application command to shut down an application specified pursuant to an additional selectable field that appears when selecting this particular command option;

a restart application command that restarts an application specified pursuant to an additional selectable field that appears when selecting this particular command option; and

an exit to Windows command that causes the vending machine's monitor application to close all applications running on the machine and to then exit to the Windows desk top.

In addition to sourcing commands to individual machines selected on a one-by-one basis, these teachings will also support issuing commands to a group of vending machines. For example, all of the machines at a particular physical location (such as a particular business building or college campus) can be commanded as a group to effect a particular command. Using this approach a user can avoid the necessity of repeating the entire command sequence over and over again when dealing with a group of machines.

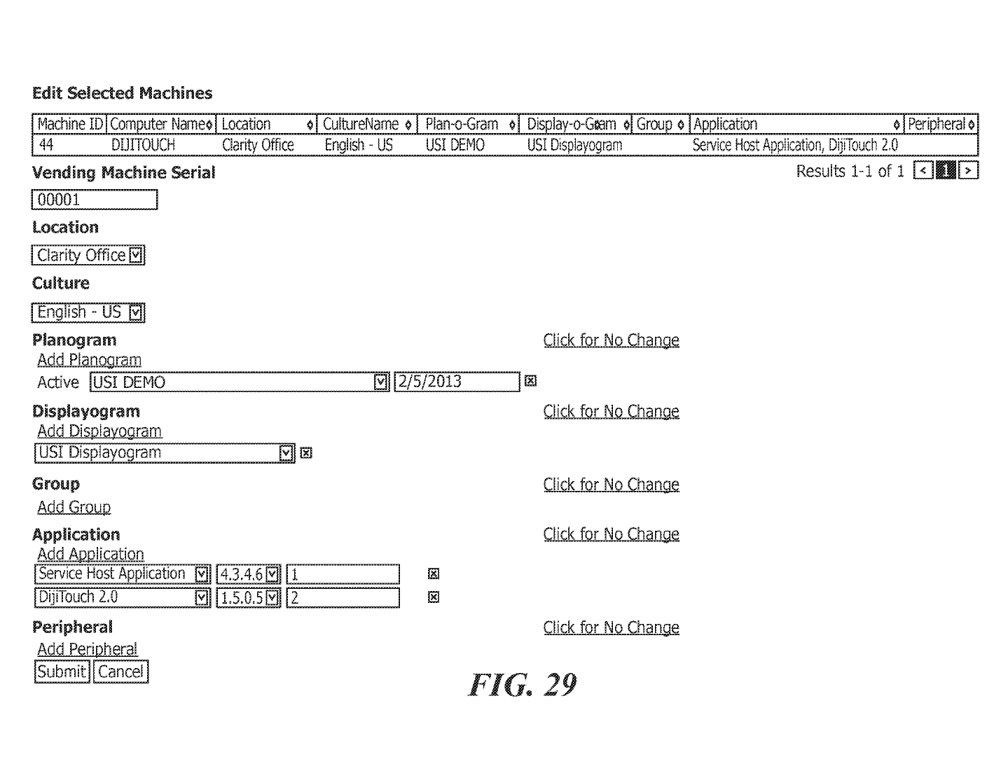

These teachings will accommodate other remote control opportunities as well. For example, by clicking on the computer name of a machine from the dashboard and edit machine page can provide the user with an opportunity to edit a single machine (or, again, a group of machines) by use of the edit machine page. FIG. 29 provides an illustrative example of such a page.

Using this approach, the administrator platform 2308 test can facilitate setting any of a variety of machine parameters including, for example:

vending machine serial number (such a field can be specified as desired by, for example, the vendor organization for administrative purposes);

location (such a field can be specified for organizational purposes; for example, such a field can serve as a high level grouping parameter based on physical location);

planogram (this parameter can specify the internal arrangement of products in the vending machine along with a date for when the new arrangement takes effect; for example, when a new planogram is assigned, that planogram has a status of “pending” until it has been accepted by the machine following which the planogram has an “active” status);

displayogram by daypart (this parameter can specify the arrangement of products on the vending machine's display 202, which are systematically changed at different times of the day as determined by preset day parts);

group (in addition to the location parameter noted above, this group parameter permits vending machines to be organized into groups via another criteria of choice as desired (with subgroups being permitted to thereby support relatively complex organizational hierarchies as may be useful to operators fielding a large number of vending machines)); and

application parameters such as a field to specify the application name, another field to specify the current version of the application, and a third field to specify the execution order as corresponds to each application (with lower numbers, for example, taking precedence over higher numbers such that an application with number 1 will initiate before an application having number 2).

The teachings set forth herein are highly flexible in practice and will accommodate a wide variety of different application settings. Those skilled in the art will appreciate numerous benefits that arise through various aspects of these teachings. A few examples of useful characterizations of these teachings include, but are not limited to:

1. A vending apparatus comprising:
a housing containing products available to be vended via the vending apparatus;
a video display configured to present dynamic content via a front surface of the housing;
at least one network interface;
a control circuit disposed within the housing and being operably coupled to the video display and the network interface, the control circuit being configured to present, via the video display, a seamless combination of promotional content as provided by a first remote source and vend-specific content.

2. The vending apparatus of characterization 1 wherein the control circuit is configured, at least in part, to present the seamless combination by seamlessly segueing between the promotional content and the vend-specific content.

3. The vending apparatus of characterization 1 wherein the control circuit is configured, at least in part, to present the seamless combination by simultaneously presenting both the promotional content and the vendor-specific content.

4. The vending apparatus of characterization 1 wherein the control circuit is configured, at least in part, to present the seamless combination by capturing and using a screenshot of the video display.

5. The vending apparatus of characterization 1 wherein the control circuit is configured, at least in part, to present the seamless combination by detecting whether a user's touch-based interaction with the video display corresponds to the promotional content.

6. The vending apparatus of characterization 1 further comprising:
a memory operably coupled to the control circuit and having stored therein the promotional content, wherein at least some discrete items of the promotional content have a corresponding use-related time provided by the first remote source.

7. The vending apparatus of characterization 6 wherein the corresponding use-related time comprises a time at which the promotional content is available to present.

8. The vending apparatus of characterization 7 wherein the promotional content comprises at least one of:
video content;
audio content;
a still image;
textual content;
executable code.

9. The vending apparatus of characterization 1 wherein the control circuit is configured, at least in part, to present the seamless combination by overlaying the promotional content with the vend-specific content.

10. A vending apparatus comprising:
a housing containing products available to be vended via the vending apparatus;
a video display configured to present dynamic content via a front surface of the housing;
at least one network interface;
a control circuit disposed within the housing and being operably coupled to the video display and the network interface, the control circuit being configured to transmit, via the network interface, a heartbeat message to a remote station.

11. The vending apparatus of characterization 10 wherein the heartbeat message includes at least one of:
vending apparatus identification information;
vending apparatus status information;
peripheral component status information;
application status information.

12. The vending apparatus of characterization 11 wherein the heartbeat message includes each of:
vending apparatus identification information;
vending apparatus status information;
peripheral component status information;
application status information.

13. A vending machine support system that facilitates remote support of at least one vending machine, the vending machine support system comprising:
at least one network interface;
a display;
a control circuit operably coupled to the network interface and the display, the control circuit being configured to facilitate designing a displayogram for the vending machine and thereafter configuring the vending machine to utilize the displayogram.

14. The vending machine support system of characterization 13 wherein the control circuit is configured to facilitate designing the displayogram by, at least in part, requiring that the displayogram present at least a minimum number of a particular category of product.

15. The vending machine support system of characterization 14 wherein the particular category of product constitutes products of a particular brand.

16. The vending machine support system of characterization 13 wherein the control circuit is configured to facilitate designing the displayogram using a drag-and-drop user interface.

17. A vending machine support system that facilitates remote support of a plurality of vending machines, the vending machine support system comprising:
at least one network interface;
a display;
a control circuit operably coupled to the network interface and the display, the control circuit being configured to issue remote commands via the network interface to the plurality of vending machines as a group.

What is claimed is:

1. A vending apparatus configured and arranged to interact with a customer via a video interface.

2. A vending machine support system that facilitates remote support of at least one vending machine.

3. The vending machine support system of claim 2 wherein the remote support includes at least one of:
providing promotional content to be presented by the vending machine;
providing planogram information regarding vendable items;
providing pricing information for vendable items.
